(19) United States
(12) Patent Application Publication
(10) Pub. No.: US 2005/0206711 A1
(43) Pub. Date: Sep. 22, 2005

(54) Method and apparatus for digital inkjet printing of materials, particularly sheet-like materials such as fabrics, hides or the like

(75) Inventor: Luigi Milini, Saronno (IT)

Correspondence Address: MODIANO & ASSOCIATI, Via Meravigli, 16, MILANO, 20123, IT

(73) Assignees: Paolo MILINI; Lucia MILINI

(21) Appl. No.: 11/125,231

(22) Filed: May 10, 2005

(30) Foreign Application Priority Data
Mar. 17, 2004 (IT) MI2004A000510

(51) Int. Cl. B41J 2/01

(52) U.S. Cl. 347/104; 347/105

(57) ABSTRACT

A method and an apparatus for digital injket printing of materials, particularly for sheet-like materials such as fabrics and hides. The method consists in arranging the material to be printed on a conveyor that supports the material to be printed on a flat surface and can be actuated in order to produce the advancement of the material to be printed along an advancement direction, in performing digital inkjet printing on one face of the material to be printed by means of at least one printing device, coordinating the actuation of the printing device with the advancement of the material to be printed along the advancement direction.

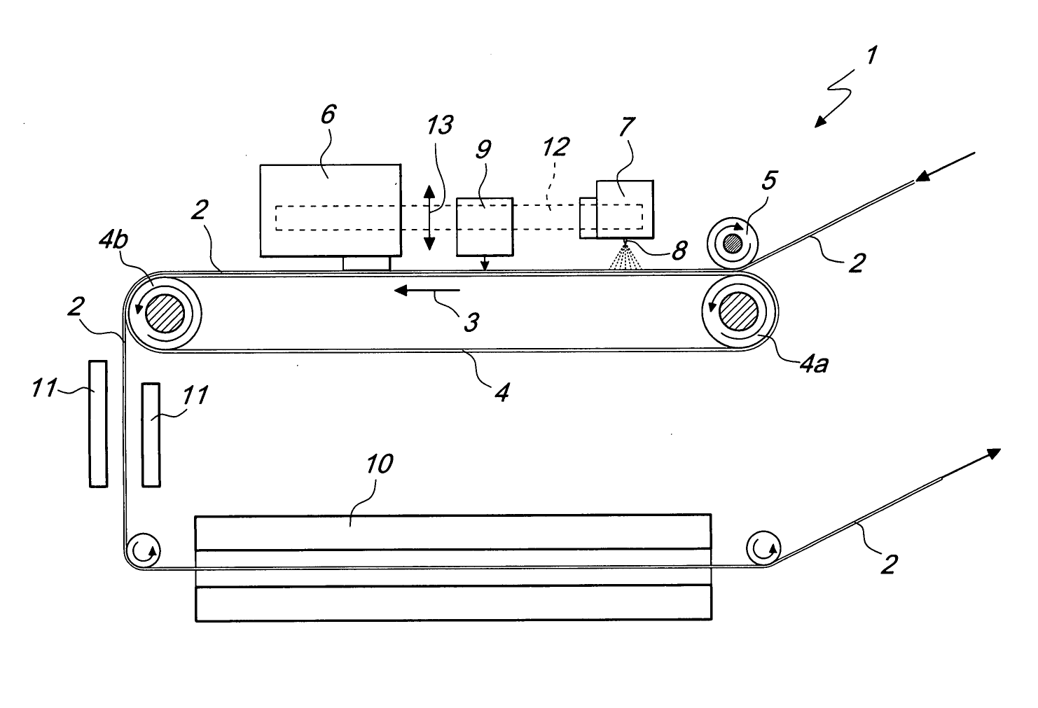

The present invention relates to a method and an apparatus for digital inkjet printing of materials, particularly for sheet-like materials such as fabrics, hides or the like.

### BACKGROUND OF THE INVENTION

It is known to print, by using digital inkjet printing devices, sheet-like materials, such as for example fabrics, natural and synthetic hides or the like, particularly when a limited production run for each print is required. A requirement of this kind is felt for example in the preparation of sets of samples of fabrics or more generally for performing print tests on fabrics, cloths, hides or the like.

To print these materials with digital inkjet printing devices, it is necessary to prepare the sheet-like material by applying to the face of the material that is to be printed a pretreatment substance for fixing the print pigments, commonly termed “thickening paste”, which acts as a vehicle for the print pigments.

In screen printing processes, particularly for fabrics and the like, the thickening paste is an integral part of the pigment that is applied to the sheet-like material during printing.

In digital inkjet printing processes, the pigments, with the addition of the thickening paste, would assume a viscosity that would prevent them from flowing uniformly through the inkjet heads. For this reason, sheet-like materials, such as fabrics, hides or the like, that are to be subjected to digital inkjet printing are pretreated with the thickening paste.

Generally, this preparation treatment or pretreatment consists in passing the sheet-like material in vats that contain the thickening paste and in then performing pad pressing in order to eliminate the excess thickening paste. The sheet-like material is then dried in machines such as a tenter or an overhead dryer.

The sheet-like material thus pretreated is ready to be subjected to digital inkjet printing.

This type of preparation suffers technical and logistic problems.

One of these problems is the fact that the thickening paste placed on the sheet-like material is abundant and has a very low degree of moisture in order to facilitate storage, which is generally performed by rolling up the sheet-like material. Because of this fact, to achieve good printing results it is necessary to use large quantities of pigment in order to penetrate through the thickening paste, with a consequence of very often having an excessive penetration in the fibers of the material and a reduced definition and clarity of the printed design.

Moreover, the preparation of the sheet-like material with conventional methods uses machines that have a far higher productivity than required for these pretreatments, which usually involve small amounts of sheet-like material. Because of this fact, there are substantial costs, which also occur in the transport and storage of the sheet-like materials both before and after the pretreatment.

### SUMMARY OF THE INVENTION

The aim of the present invention is to solve the problems described above by providing a method and an apparatus for digital inkjet printing of materials, particular for sheet-like materials such as fabrics, hides or the like, which by eliminating the need for pretreatment of the material to be printed with conventional pretreatment systems allows to reduce considerably the corresponding costs.

Within this aim, an object of the invention is to provide a method and an apparatus that also allow to reduce the amount of printing pigments, with distinctly improved print results in terms of definition and clarity, with respect to what can be achieved with digital inkjet printing on materials pretreated with conventional methods.

Another object of the invention is to provide a method and an apparatus that by eliminating the need to resort to conventional pretreatment systems also reduces considerably the overall times required for execution of digital inkjet printing.

Another object to the invention is to provide an apparatus that is capable of performing digital inkjet printing of materials that are fed to the apparatus without being pretreated with thickening paste.

Another object of the invention is to provide an apparatus that also allows to print materials of different thicknesses, optionally mounted on supporting frames.

This aim and these and other objects that will become better apparent hereinafter are achieved by a method for digital injket printing of materials, particularly for sheet-like materials such as fabrics, hides or the like, which consists in arranging the material to be printed on a conveyor that supports the material to be printed on a flat surface and can be actuated in order to produce the advancement of the material to be printed along an advancement direction, in performing digital inkjet printing on one face of the material to be printed by means of at least one printing device, coordinating the actuation of said printing device with the advancement of the material to be printed along said advancement direction, characterized in that during the advancement of the material to be printed along said advancement direction, a pretreatment substance for fixing the print pigments is applied to the face of the material to be printed before the material to be printed undergoes the action of said printing device.

To perform the method according to the invention, an apparatus for digital inkjet printing of materials, particularly sheet-like materials such as fabrics, hides or the like, is used which comprises means for supporting on a flat surface the material to be printed, means for the advancement of the material to be printed along an advancement direction, and a digital printing device provided with inkjet printing heads that face the material to be printed that is deposited on said supporting means and is functionally connected to said advancement means for the gradual printing of the face of the material to be printed that is directed toward said printing device during its advancement along said advancement direction, characterized in that it comprises means for applying a pretreatment substance for fixing the print pigments, said application means being arranged upstream of said printing device along the advancement direction imparted to the material to be printed by said advancement means.

### BRIEF DESCRIPTION OF THE DRAWING

Further characteristics and advantages of the invention will become better apparent from the description of a preferred but not exclusive embodiment of the method and the apparatus according to the invention, illustrated by way of non-limiting example in the accompanying drawings, wherein the only FIGURE is a schematic view of an apparatus according to invention.

### DESCRIPTION OF THE PREFERRED EMBODIMENTS

With reference to the FIGURE, the apparatus according to the invention, generally designated by the reference numeral 1, comprises means for supporting on a flat surface the material 2 to be printed and means for the advancement of the material 2 along an advancement direction, indicated by the arrow 3.

The supporting means and the advancement means are preferably constituted by a conveyor belt 4 that winds around at least one pair of rollers 4a and 4b, which have substantially horizontal axes that are perpendicular to the advancement direction 3. The conveyor belt 4 is preferably provided so that its upper portion, which forms a supporting surface for the material 2, is arranged on a substantially horizontal plane. In this manner, the material 2, once it has been rested on the upper portion of the conveyor belt 4, has the face to be printed directed upward.

The apparatus according to the invention is intended to be used mainly for printing sheet-like materials, and in this case the conveyor belt 4 is conveniently provided with means for retaining and blocking the material 2 deposited on its upper portion. Such retention and locking means can be constituted for example, in a per se known manner, by a layer of reusable adhesive that is applied to the face of the conveyor belt 4 that is designed to support the material 2.

At the beginning of the upper portion of the conveyor belt 4, along the advancement direction 3, it is possible to arrange a presser roller 5, which is designed to make the material 2, if it is constituted by a sheet-like material, adhere to the adhesive layer of the conveyor belt 4 gradually as it is deposited thereon.

A digital printing device 6 is arranged above the conveyor belt 4 and is provided with inkjet printing heads that face the upper portion of the conveyor belt 4. The digital printing device 6 can be constituted, in a per se known manner, by a plotter with print heads that can move transversely to the advancement direction 3.

The printing device 6 is functionally connected, in a per se known manner, to the actuation elements of the conveyor belt 4 so that the actuation of the print heads is coordinated with an intermittent advancement of the conveyor belt 4 in order to gradually print the upper face of the material 2 that advances along the advancement direction 3.

The apparatus according to the invention comprises means 7 for applying a pretreatment substance for fixing the printing pigments to the material 2. Applicator means 7 are arranged upstream of the printing device 6 along the advancement direction 3.

The pretreatment substance can be constituted by one of the known types of pretreatment substances currently applied, with the technique that provides for passage through a vat with subsequent pad pressing, to materials such as fabrics, hides or the like to be subjected to digital inkjet printing. Said pretreatment substance can vary according to the type of print pigments used by the digital printing device 6.

The applicator means 7 are preferably constituted by at least one spray nozzle 8 for dispensing the pretreatment substance, which faces the face to be printed of the material 2. Preferably, the nozzle 8 can move, in a manner similar to the print heads of the printing device 6, transversely to the advancement direction 3.

The nozzle 8 also is preferably functionally connected to the elements for the actuation of the conveyor belt 4, so as to dispense the pretreatment substance in a manner that is correlated with the advancement of the conveyor belt 4 in order to achieve the most uniform possible application of said substance to the face of the material 2 to be printed.

As an alternative, the applicator means 7 can be constituted, instead of by one or more spray nozzles, by a roller or doctor spreading means, arranged above the upper face of the material 2 deposited on the conveyor belt 4.

Between the applicator means 7 and the printing device 6 drying means 9 are provided, which dry, with a preset residual humidity, the pretreatment substance dispensed by the applicator means 7 to the material 2.

Said drying means 9 can be constituted by one or more hot air dispensers that face the face of the material 2 to be printed.

Hot air dispensing is adjusted so as to obtain, for the pretreatment substance, upon arrival at the printing device 6, a residual humidity that is ideal for the printing process.

In practice, the pretreatment substance, upon arrival at the printing device 6, can have a higher residual humidity than it would if it were applied with conventional techniques and dried in machines of the tenter or overhead dryer type. In this way, it is possible to achieve qualitatively improved printing in terms of clarity and definition, avoiding excessive penetration and using smaller amounts of printing pigments.

Downstream of the printing device 6 along the advancement direction 3 means are provided for heat-fixing the printing pigments to the textile or other fibers of the material 2. Depending on the type of printing pigments used, the heat-fixing means can be constituted by hot air dispensers for the polymerization of polymerizable printing pigments or by a vaporization chamber 10, as shown, using saturated steam for other types of printing pigment.

It is possible to provide, between the printing device 6 and the heat-fixing means, means 11 for hot air drying of the printed material 2.

Advantageously, the means 7 for applying the pretreatment substance, the digital printing device 6 and the drying means 9 can be mounted on a supporting structure 12, shown only schematically for the sake of simplicity, which can move on command along a substantially vertical direction 13 in order to vary the distance of the elements arranged thereon from the surface formed by the upper portion of the conveyor belt 4, so as to allow to adapt such distance to the thickness of the material 2 being printed. In this manner, it is possible to print without problems materials 2 that have different or variable thicknesses and it is also possible to print materials mounted on supporting frames. In this case, the roller 5 can be lifted in order to allow to load onto the conveyor belt 4 the frames that support the material 2 to be printed.

It should be noted that the vaporization chamber 10 and the drying means 11 may be arranged and structured in different manners in order to meet space requirements and to adapt to the type of material 2 being printed. Moreover, the vaporization chamber 10 and the drying means can be mounted on the same machine that performs printing or can be installed separately with respect to the printing machine.

Operation of the apparatus in performing the method according to the invention is as follows.

The material 2 to be printed is loaded gradually onto the upper portion of the conveyor belt 4. If the material 2 is constituted by a sheet-like material, it is pressed onto the conveyor belt 4 by the presser roller 5, which makes it adhere to the conveyor belt 4 without the possibility of accidental slippage. If instead the material 2 is supported by frames, said frames are simply placed and optionally locked on the conveyor belt 4 after lifting the roller 5.

The actuation of the conveyor belt 4 causes the gradual advancement of the material 2 along the direction 3, moving it below the applicator means 7, which apply thereto the pretreatment substance for fixing the printing pigments.

While the material 2 passes at the drying means 9, said substance is dried with a preset degree of residual humidity that is ideal for the subsequent printing operation.

The material 2, by then passing at the printing device 6, is gradually printed.

It should be noted that printing with an inkjet head requires intermittent advancement of the material 2 along the advancement direction 3. Actuation of the applicator means 7 and optionally actuation of the drying means 9 can be performed as a function of this intermittent advancement, so as to achieve the most uniform possible application and drying of the pretreatment substance.

Downstream of the printing device 6, the printed material 2 is subjected to drying, by means of the drying means 11, and to heat-fixing of the printing pigments by polymerization or vaporization in the vaporization chamber 10.

In practice, the apparatus and the method according to the invention, thanks to the fact that the pretreatment substance is applied “in line”, i.e., almost simultaneously with the printing operation, avoids performing the pretreatment at separate times and with separate machines, allowing to optimize the printing operation with qualitatively improved results.

In practice it has been found that the method and the apparatus according to the invention fully achieve the intended aim, since they allow a considerable saving as regards the costs required for the pretreatment operation.

Another advantage of the method and of the apparatus according to the invention is that they achieve improved printing results with lower amounts of printing pigments.

Another advantage of the method and of the apparatus according to the invention is that it is possible to perform digital inkjet printing of materials that are not treated beforehand and therefore with considerably shorter execution times than required by conventional methods.

Another advantage of the method and of the apparatus according to the invention that arises from the reduction in times and costs that they achieve is that it becomes possible to adopt, in an economically convenient manner, digital printing even for substantially larger production runs than obtainable with conventional methods.

Although the method and the apparatus according to the invention have been conceived particularly for printing sheet-like materials, they can be used more generally also for digital printing of other materials.

The method and the apparatus thus conceived are susceptible of numerous modifications and variations, all of which are within the scope of the inventive concept; all the details may further be replaced with other technically equivalent elements.

In practice, the materials used, so long as they are compatible with the specific use, as well as the dimensions, may be any according to requirements and to the state of the art.

The disclosures in Italian Patent Application N. MI2004A000510, from which this application claims priority, are incorporated herein by reference.

1. A method for digital injket printing of materials, particularly for sheet-like materials such as fabrics, hides or the like, which consists in arranging the material to be printed on a conveyor that supports the material to be printed on a flat surface and can be actuated in order to produce the advancement of the material to be printed along an advancement direction, in performing digital inkjet printing on one face of the material to be printed by means of at least one printing device, coordinating the actuation of said printing device with the advancement of the material to be printed along said advancement direction, wherein during the advancement of the material to be printed along said advancement direction, a pretreatment substance for fixing the print pigments is applied to the face of the material to be printed before the material to be printed undergoes the action of said printing device.

2. The method according to claim 1, wherein the application of said pretreatment substance is correlated to the advancement of the material to be printed along said advancement direction.

3. The method according to claim 1, wherein said pretreatment substance is applied by spraying to said face of the material to be printed.

4. The method according to claim 1, wherein said pretreatment substance is applied by spreading to said face of the material to be printed.

5. The method according to claim 1, wherein after applying said pretreatment substance and before printing, said pretreatment substance is dried with a preset residual humidity.

6. The method according to claim 1, wherein the printed material is subjected to heat-fixing of the printing pigments after printing.

7. The method according to claim 6, wherein said heat-fixing of the printing pigments is performed by striking the printed material with saturated steam.

8. The method according to claim 6, wherein said heat-fixing of the printing pigments is performed by striking the printed material with a stream of hot air.

9. The method according to claim 6, wherein the printed material is subjected to drying after printing and before said heat-fixing.

10. An apparatus for digital injket printing of materials, particularly sheet-like materials such as fabrics, hides or the like, comprising means for supporting on a flat surface the material to be printed, means for the advancement of the material to be printed along an advancement direction, and a digital printing device provided with inkjet print heads that face the material to be printed, which is deposited on said supporting means and is functionally connected to said advancement means for the gradual printing of the face of the material to be printed that is directed toward said printing device during its advancement along said advancement direction, the apparatus further comprising applicator means for applying a pretreatment substance for fixing the printing pigments, said applicator means being arranged upstream of said printing device along the advancement direction imparted to the material to be printed by said advancement means.

11. The apparatus according to claim 10, wherein said supporting means form a supporting surface for the material to be printed that is substantially horizontal in order to expose the face of the material to be printed so that it faces upward.

12. The apparatus according to claim 10, wherein said supporting means and said advancement means comprise a conveyor belt, which is arranged so that its upper portion, intended to support the material to be printed, lies on a substantially horizontal plane.

13. The apparatus according to claim 12, wherein said conveyor belt is provided with means for retaining and locking the material to be printed that is deposited on said conveyor belt.

14. The apparatus according to claim 10, wherein said applicator means comprise at least one spray nozzle, which faces the face to be printed of the material arranged on said supporting means.

15. The apparatus according to claim 14, wherein said at least one spray nozzle is functionally connected to said advancement means in order to dispense said pretreatment substance in a manner that is correlated to the advancement of the material to be printed along said advancement direction.

16. The apparatus according to claim 14, wherein said applicator means comprise means for spreading said pretreatment substance on the face to be printed of the material.

17. The apparatus according to claim 14, wherein said at least one spray nozzle can move on command transversely to said advancement direction.

18. The apparatus according to claim 10, wherein means for drying with a preset residual humidity said pretreatment substance are arranged between said applicator means for applying the pretreatment substance and said printing device.

19. The apparatus according to claim 18, wherein said drying means comprise hot air dispensers that face the face to be printed of the material.

20. The apparatus according to claim 10, wherein said digital printing device is constituted by a plotter with print heads that can move transversely to said advancement direction.

21. The apparatus according to claim 10, further comprising, downstream of said printing device along said advancement direction, means for heat-fixing the printing pigments.

22. The apparatus according to claim 21, wherein said means for heat-fixing the printing pigments comprise hot air dispenses.

23. The apparatus according to claim 21, wherein said means for heat-fixing the printing pigments comprise a vaporization chamber that is arranged downstream of said printing device and is crossed by the printed material.

24. The apparatus according to claim 21, wherein means for drying the printed material are arranged between said printing device and said heat-fixing means.

25. The apparatus according to claim 24, wherein said applicator means for applying a pretreatment substance, said digital printing device and said drying means are mounted on a supporting structure that can move along a substantially vertical direction in order to vary their distance from the plane traced by said supporting means.
